(19) United States
(12) Patent Application Publication
(10) Pub. No.: US 2010/0136156 A1
(43) Pub. Date: Jun. 3, 2010

(54) PLANT FOR PRODUCTION OF CONCRETE

(75) Inventor: Charles Bergling, Kungalv (SE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: INGENJÕRSFIRMA HEBE AB, Kungalv (SE)

(21) Appl. No.: 12/595,598

(22) PCT Filed: Apr. 11, 2008
(86) PCT No.: PCT/SE2008/000262

§ 371 Date: Oct. 12, 2009

(30) Foreign Application Priority Data
Apr. 12, 2007 (SE) 0700887-3

(51) Int. Cl. B28B 5/02

(52) U.S. Cl. 425/453

(57) ABSTRACT

The invention relates to a plant for the production of concrete, comprising a mould for a molded concrete mass (14), the mould comprising a mould base and a wall construction (2) that can be removed from said mould base. The mold base of the mold comprises an upper part (26) of a first conveyor belt (1).

### TECHNICAL FIELD

The invention relates to a plant for the production of concrete. In particular the invention relates to a plant for the production of blocks, beams or elements of lightweight or aerated concrete.

### BACKGROUND ART

Conventional plants for the production of blocks, beams or elements of lightweight concrete (aerated concrete) are known in various embodiments, but generally comprise a raw materials section, a casting station with a mold bay, foaming chamber equipment, a cutting unit for dividing the set and plastic mold mass up into smaller blocks or elements, an autoclave section for curing the mold mass and an unloading section for the cured and divided mold masses.

The raw materials section receives and is capable of storing the raw material, which is primarily silica sand, cement, lime and water. Instead of sand, it is also possible, among other things, to use fly ash, which comes from coal-fired power stations. The dry or wet sand is processed to a high degree of fineness in an agitator mill and is stored in a silo or slurry tank with agitator. The cement, usually Portland cement, is stored directly in a silo. The lime may be purchased and delivered directly in a silo according to the required quality and fineness or it is delivered with the required quality and grain size and then processed to the required fineness and stored in a silo. Smaller quantities of certain admixtures, such as gypsum, may be used.

The casting station with a mixer receives the raw material from the raw materials section via conveyors and weighing arrangements and mixes it with the addition of water to a slurry, which finally has a smaller quantity of aluminum powder added for the foaming operation, following which the slurry is discharged into a mold.

The mold, usually made of steel, is conveyed to the so-called foaming chamber for mounting during the foaming and setting period, in which the mass assumes a porous, plastic state and fills the entire mold. The foaming chamber often has rails inset into a concrete floor and chain conveyors, for example, which convey each mold on wheeled trolleys to the mounting place. Instead of chain conveyors, automatic roller conveyors are also used. The foaming chamber can usually accommodate 10-20 molds during the foaming and setting period, which can take 1-2 hours.

From the foaming chamber each mould is then conveyed to the cutting unit, in which the walls of the mould are removed, so that the cutting wires, (steel wires) can run through the plastic mass in two directions at 90° to one another, so that the content of the mould is divided up into blocks, beams or elements, for example. The bottom, top and sides of the plastic mass are clean cut in order to obtain the precise dimensions of the finished products. The outer layer of the molded mass that is cut away, the so-called waste, is collected together and returned to a suspension in one or more containers with agitators, and then returned to the casting station for reuse in the production in each casting process.

When the molded mass leaves the cutting unit, the end product is conveyed onwards, for example on the mould bases or separate steel pallets, to the autoclave section for steam curing, usually for a curing time of 8-11 hours. The autoclave section comprises autoclaves, a steam boiler with valves and pipelines to each autoclave, rails or roller conveyors for conveying in the autoclaves and conveyors for feeding the products in and out.

The final element is the unloading unit, which normally comprises overhead travelling cranes for conveying the products to transport or storage pallets for handling by means of forklift trucks, either for delivery or for placing in storage.

A general problem with conventional plants of this type is that they take up a lot of space, due to the large amount of space that is required for laying out the uncured and cured material. Another general problem is that such plants are labor-intensive, since they require a lot of manual labor, for transporting trolleys with the associated monitoring and the collection and distribution of waste, for example.

### DISCLOSURE OF INVENTION

The object of the present invention is to provide a plant for the production of concrete, in particular aerated or lightweight concrete, which takes up less space, is less labor-intensive and more efficient than existing plants. This object is achieved by a plant as described and claimed herein. Advantageous embodiments, developments and variants of the invention are also described and claimed herein.

The invention relates to a plant for the production of concrete, comprising a mold for a molded concrete mass, the mould comprising a mold base and a wall construction that can be removed from said mold base. In the plant according to the invention the mold base of the mold may consist of an upper part of a conveyor belt, the wall construction being designed to accompany the molded concrete mass and to hold it together when the conveyor belt is in operation.

An advantageous effect of such a plant is that it is no longer necessary to use separate mold bases. This in turn avoids long, complicated conveyors that take up a lot of space in order to convey mould bases around the plant, and it is furthermore no longer necessary to prepare a separate space for setting up the mold bases.

Another advantageous effect is that use of the conveyor belt as mould base means that the molded mass already rests on a conveyor belt at an early stage in the process, with the result that the molded mass can easily be conveyed onwards in the plant, for example through the cutting unit. Such a use of conveyor belts brings improvements both in the cutting process, in which the action of the cutting machines, for example, can be rationalized, since there is no longer any need to adjust to an accompanying mold base, and in the handling of waste, in which conveyor belts can be used for automatic removal.

In an embodiment of the invention, guide devices are arranged along each side of the upper part of the first conveyor belt, said guide devices being designed, when the conveyor is in operation, to interact with an outer part of the wall construction for positioning the wall construction in a transverse direction to the longitudinal direction of the first conveyor belt. Both the wall construction and the upper part, that is to say the belt of the conveyor, can thereby be guided laterally, for centering when feeding into cutting arrangements, for example. The guide devices may consist of guide rollers.

In an embodiment the upper part of the first conveyor belt is of a length which allows at least two wall constructions in succession to be placed thereon. This allows one wall construction to be filled with a mold charge whilst a further mold charge is undergoing foaming.

In an embodiment a second conveyor belt is arranged in connection with the first conveyor belt, it being possible to synchronize the operation of the second conveyor belt with the first conveyor belt, so that an at least partially set molded concrete mass can be transferred from the first conveyor belt to the second conveyor belt. The two conveyor belts can thereby be driven independently of one another. The second conveyor belt can then be used, without interference from a disconnected first conveyor belt, to allow the molded mass to go on foaming, in order to allow the wall construction to be raised, so as to convey the molded mass to or through a cutting unit, as an intermediate station for onward transfer to a further conveyor belt, or for combinations of these.

In an embodiment a third conveyor belt is arranged in connection with a preceding conveyor belt, it being possible to synchronize the operation of the third conveyor belt with the preceding conveyor belt, so that an at least partially set molded concrete mass can be transferred from the preceding conveyor belt to the third conveyor belt, one or more cutting machines for machining of the molded concrete mass being arranged in connection with the third conveyor belt. The third conveyor belt can thereby be driven independently of preceding conveyor belts, for example independently of a conveyor belt which moves step-by-step, in order to allow the addition of mold charges, so that the operation of the third conveyor belt can be optimized with regard to the cutting operation.

In a preferred embodiment the preceding conveyor belt consists of the second conveyor belt. In this way the aforementioned advantages and facilities are achieved with just three conveyor belts.

### BRIEF DESCRIPTION OF DRAWINGS

The invention will now be described in more detail with reference to the following drawings, in which

FIG. 1 shows a schematic top view of a plant for the production of lightweight concrete according to a preferred embodiment of the invention,

FIG. 2 shows a side view of part of the embodiment according to FIG. 1,

FIG. 3 shows a side view of a wall construction according to a preferred embodiment,

FIG. 4 shows a top view of a wall construction according to FIG. 3,

FIG. 5 shows a cross section A-A of the wall construction according to FIG. 3, and

FIG. 6 shows a cross section of a fully foam lightweight concrete mass in a wall construction according to FIG. 3, placed on a conveyor belt according to a preferred embodiment.

### MODE(S) FOR CARRYING OUT THE INVENTION

The plant according to the invention differs from a conventional plant producing lightweight concrete primarily in the production part, from the casting station to the autoclave section.

Separate steel moulds, which are conveyed on rail-based trolleys with chain conveyors, roller conveyors or with overhead travelling cranes, have been replaced by flat conveyor belts 1, 3, 4 and wall constructions 2, which together form a number of moulds in casting, foaming and cutting units 41, 42.

Each mold is formed from a section of an upper part 26 of the conveyor belt 1, which constitutes the mold base, and a wall construction 2, which forms the longitudinal and short sides of the mold. The more or less set mass of lightweight concrete situated in the mold is referred to as the molded (concrete) mass 14.

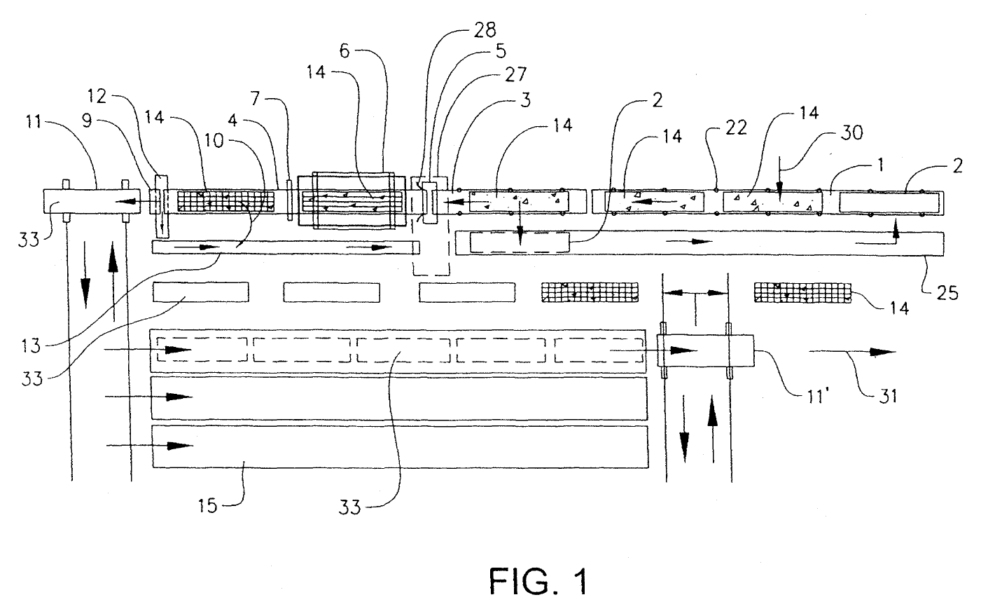

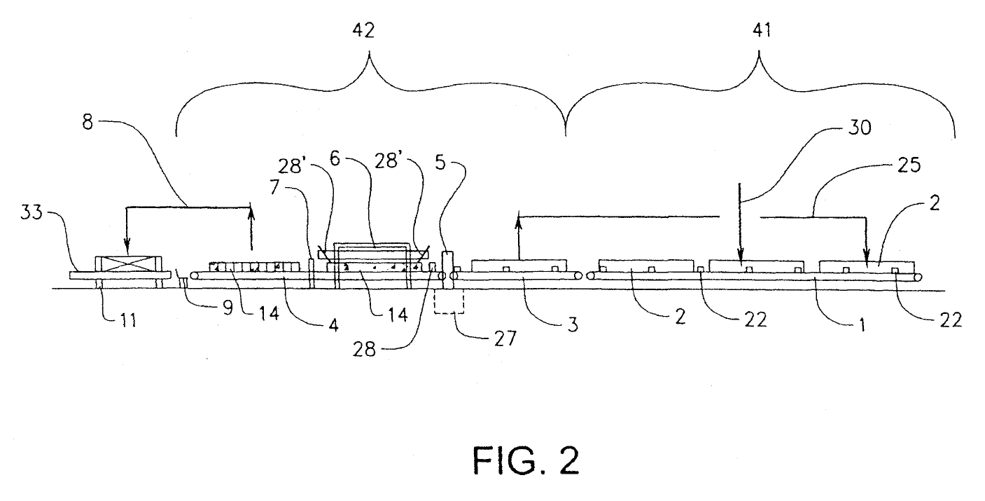

FIG. 1 shows a schematic top view of a plant for the production of lightweight concrete according to a preferred embodiment of the invention. FIG. 2 shows a side view of a part of the embodiment according to FIG. 1, essentially the casting and foaming unit 41 and the cutting unit 42.

The plant according to FIGS. 1 and 2 also comprises a raw materials unit and a casting station, which are not shown. The casting station is indicated schematically by an arrow 30, which shows where molding mass is added to the mould.

According to FIGS. 1 and 2 the first conveyor belt 1 operates in the casting and foaming unit 41 and is provided with a drive unit, which through a transmission and coupling can be synchronized with and can drive a second conveyor belt 3 during its step-by-step feeding of the molds. Drive units, transmission and coupling are well known in the art and are therefore not shown in the drawings or described in detail here.

When the wall construction 2 and associated molded concrete mass 14 are conveyed through step-by-step feeding over to the second conveyor belt 3, and consequently change mold base, the operation is isolated from the conveyor belt 1. The wall construction 2 and the mold mass 14 then become stationary in a specific position on the second conveyor 3 directly beneath a lifting arrangement forming part of a lifting and conveying arrangement 25 for the wall constructions 2. The wall constructions 2 are raised in this position and are transported by a chain or belt conveyor back to an end station for the first conveyor belt 1, which is situated one stage away from a casting station (indicated by an arrow 30), the wall construction 2 together with a section of the upper part 26 of the conveyor belt 1 again forming a new mould ready to receive a mold charge 30.

The wall construction 2 is a separate, free-standing, self-supporting unit designed to accompany the molded mass 14 on the conveyor belt until the molded mass 14 has set sufficiently, at which point the wall construction 2 is lifted off and is returned to the casting station.

The aforementioned arrangement results in a short line and easy handling in order to manage the molds, that is to say the wall constructions 2. In contrast to conventional plants, the mold base does not accompany the molded concrete mass 14 on through the plant.

The exposed molded mass 14 on the second conveyor belt 3 is now ready for dividing up into smaller units.

FIGS. 1 and 2 also show guide devices 22 in the form of guide rollers, which are arranged along each side of upper sections of the first and second conveyor belts 1, 3. These guide devices 22 are designed to interact with an outer part 19 of the wall construction 2, more specifically a guide rail (see FIG. 5), for positioning the wall construction 2 in a transverse direction to the longitudinal direction of movement of the conveyor belts 1, 3 when the wall construction 2 is transported on the first and second conveyor belts 1, 3.

A third conveyor belt 4 in the cutting unit 42 has its own drive unit with transmission and coupling for synchronized connection to the second conveyor belt 3, and can then undertake all transport within the cutting unit 42 to existing cutting arrangements 5, 6, 7, once a mold/molded mass 14 has automatically stopped on the second conveyor belt 3 due to the step-by-step transport from the first conveyor belt 1, as described above.

A longitudinal cutting machine 5 is located in a space that occurs between the end rollers of the second and third conveyor belts 3, 4. The longitudinal cutting machine 5 comprises a cutting frame through which the molded mass 14 passes. The frame, which supports the vertical cutting wires, has a reciprocating motion and divides the molded mass 14 up into a number of units in a longitudinal direction. This division corresponds to the thickness of the building block or the element.

Such a location and use of a cutting frame is therefore possible due to the fact that the molded concrete mass 14 is conveyed without a mold base on the conveyor belts, which are arranged in connection with one another.

Through automatic engagement of the drive unit on the third conveyor 4, the molded mass 14 is now transported from the second conveyor 3 through the cutting frame on the longitudinal cutting machine 5 over to the third conveyor 4 and stops automatically in a specific position directly beneath a cross-cutting machine 6, the cutting wires of which have a starting position directly above the top of the molded mass 14. In this position the drive unit for the third conveyor 4 is automatically isolated from the second conveyor 3, which is reconnected to the drive unit for the first conveyor 1, and the second conveyor 3 is then ready to receive a new mold.

The connection of the second conveyor belt 3 both to the first conveyor belt 1 and to the third conveyor belt 4 can therefore be synchronized. The synchronized connection of the two conveyor belts, between which the molded mass 14 is to be transferred, means that the belts, that is to say the upper part and lower part of the conveyor belts, move simultaneously and at the same speed, which affords a smooth and easy transfer of the molded mass 14.

When the synchronized operation is disengaged, each conveyor belt 1, 3, 4 can be driven independently of the other conveyor belts.

The molded mass 14 remains stationary under the cross-cutting machine 6 during the cutting operation, which takes place with the overlying cutting wires at 90 degrees to the longitudinal direction of the molded mass 14. As in other cutting operations, the cross-cutting machine 6 is designed to impart a reciprocating motion to the cutting wires. This affords a controlled cutting and prevents material being torn away from the molded mass 14 during cutting, especially when the cutting wires leave the molded mass 14. In the cutting operation the cutting wires are lowered down through the molded mass 14 to a bottom position close to the upper part of the belt on the third conveyor belt 4. After a short while in the bottom position, the cutting wires return to a starting position directly above the molded mass 14.

The third conveyor belt 4 then moves the molded mass 14, divided up into blocks or elements, to an end station under a first vacuum lift (symbolized by an arrow 8, see FIG. 2). In the course of this movement the molded mass 14 passes a top and bottom cutting machine 7, which has two parallel, reciprocating cutting wires, which are located at 90 degrees to the longitudinal direction of the third conveyor belt 4, and at a vertical interval from one another equal to the precise length of the block or the precise width of the element.

The clean-cut molded mass 14 leaves a waste mass, which varies in volume according to the size of the mould, that is to say of the wall construction 2, and is calculated to be approximately 15% of the foamed volume of the mould charge/molded mass 14.

Using the plane third conveyor belt 4 in the cutting unit facilitates handling of the mould waste, which can then be performed fully automatically.

In the longitudinal cutting machine 5 it is the outer cutting wires that determine the lateral wastage. This waste is dealt with by ploughs 28, which are located between the longitudinal and cross-cutting machines 5, 6. The waste is led over the outer edges of the conveyor belt down into a collecting tank 27 with horizontal agitators (not shown), which has an automatic water top-up for obtaining a slurry with a specific weight per unit volume.

The short-side wastage of the molded mass 14 is handled in the cross-cutting machine 6 during the cross cutting operation, since the outer wires of the machine determine the clean-cut length for the molded mass 14. On the frame of the cross-cutting machine 6 moving up and down, with arrangements for the cutting wires, ploughs 28′ are installed directly above the two outer cutting wires and follow these, knocking the waste down onto the plane upper part of the belt on the third conveyor belt 4, where it is then transported to the end station. When the molded mass 14 has been removed by the vacuum lift 8, this waste is fed over the end roller of the third conveyor belt 4 down onto a fourth conveyor belt 12 and thence onwards by means of a fifth conveyor belt 13 to the collecting tank 27.

As described previously, the top and bottom cutting machine 7 is installed after the cross-cutting machine 6, which defines the top and bottom wastage. The bottom wastage, which rests on the third conveyor belt 4, accompanies the upper part thereof together with the short-side wastage over the end roller and down onto the conveyor belt 12 and 13 for onward transport to the collecting tank 27.

The top wastage is lifted by a second vacuum lift (symbolized by an arrow 10, see FIG. 1) and is transported to a receiving pocket over the fifth conveyor belt 13 for onward transport to the collecting tank 27, where all the waste is mixed with water to a slurry of a specific weight per unit volume. The slurry is then pumped to the casting station 30, which has an automatically functioning weighing vessel for correct metering of each mold charge.

The vacuum lift 8, mounted on an overhead travelling crane, lifts and finally transports the finished molded mass 14 to an autoclave pallet 33, that is to say a steel construction for transporting the molded mass 14 on through an autoclave 15, which is located on a first floor travelling crane for onward conveying to the intended autoclave 15, to undergo the curing process.

During the horizontal transport of the vacuum lift 8 to the floor travelling crane 11, the bottom surface of the molded mass 14 passes a tightly adjacent cutting wire, forming part of the bottom cleaner 9, the function of which is to ensure that all the bottom wastage is removed from the bottom surface of the molded mass 14, before it is lowered down onto the autoclave pallet 33.

The plant comprises three parallel autoclaves 15, which can all be fed by the floor travelling crane 11. The autoclave pallet 33 with associated molded mass 14 is transported on roller conveyors on the floor travelling crane 11, into the autoclave 15 and on a second floor travelling crane 11′ after having passed through the autoclave 15. The autoclave and the cured molded mass 14 are rolled off to a roller conveyor line which is parallel to the autoclaves and which is used in order to return the pallet 33 to the first floor travelling crane 11. Before the pallet 33 is returned, the cured lightweight concrete molded mass 14 is lifted off by means of an overhead travelling crane (not shown) and is carried by means of a further conveyor belt and overhead travelling crane (not shown) for packing and unloading 31.

The plant may advantageously be continuously automated. Each plant has a specific cycle time which is identical for each working operation from casting to unloading. The number of autoclaves is important for the efficiency of the plant and the time taken for the curing process in the autoclave. If an overall time of 10 hours is assumed for the curing process, including the build-up and reduction of the steam pressure, which may be in the order of 12-13 kg/cm², for example, each autoclave is used 2.4 times during one day's continuous operation.

In the plant described by way of example here, there are three autoclaves 15, of which one is always under steam pressure and functions as charging autoclave. The cycle time is 30 minutes, that is to say it takes five hours to charge the autoclave and an equal length of time to remove the cured material from the autoclave. Furthermore, the net dimensions of the mold are 6000×1200×600 mm (length×width×height), which gives a molded mass 14 having a net volume of 4.32 m³. The autoclaves are designed to accommodate five pallets lengthwise and two in a vertical direction, which means that ten molded masses 14 can be accommodated simultaneously in each autoclave. The capacity of the plant described in continuous operation will then be: 2 (number of autoclaves in operation)×2.4 (autoclave utilization)×10 (number of molded masses)×4.32 (net volume)=208 m³/day. With 300 days' production per year, this gives approximately 62,200 m³/year.

The number of autoclaves may be varied. In order to double the production, for example, the number of autoclaves can be increased to five, so that the number of autoclaves in operation is doubled from two to four.

The fact that one autoclave serves as charging autoclave is an advantage compared to the alternative of having a separate setup line in advance of the autoclaves. This firstly avoids additional handling when the moulds have to be moved from the setup line to the autoclave and secondly the autoclave is still hot, which benefits the molded mass to be cured.

The first, second and third conveyor belts 1, 3, 4 have continuous belts with an upper and a lower part. It is important that these conveyor belts 1, 3, 4, and especially the first conveyor belt 1 on which the mold charge is added, should have a plane upper part, since part of this serves as a mold base. Steel belting may be used but reinforced rubber belting is very suitable in this case, with a view, among other things, to the wall construction 2 bearing against the rubber surface so as to prevent leakage. In addition, rubber belting allows the end rollers to have relatively small diameters, which is advantageous when the molded mass 14 is being transferred from one conveyor to another.

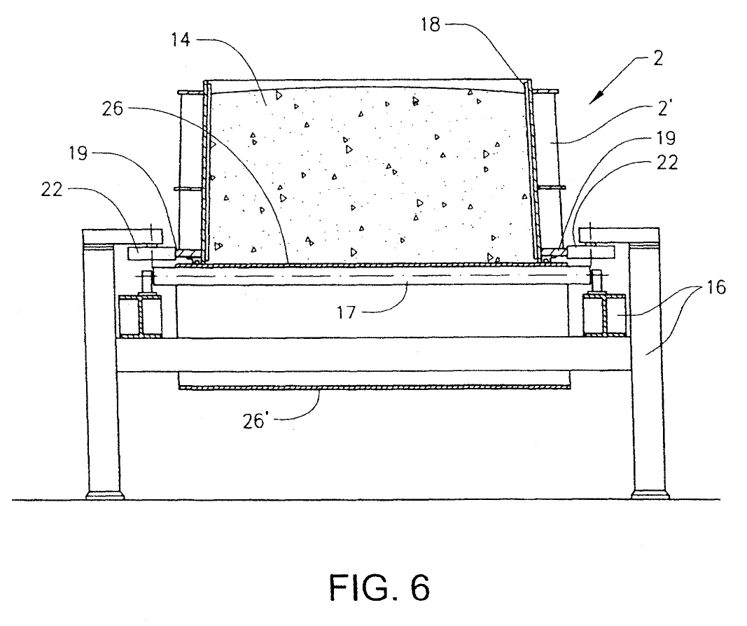

The underlying surface on which the upper part 26 of the belt (see FIG. 6) rests may consist of a fixed steel or wooden surface. However, the underlying surface may consist of tightly seating ball bearing transport rollers, the belt being sufficiently tensioned to reduce the sag between the conveying rollers to an acceptable value. An acceptable value for the sag is approximately 0.5-1 mm. A certain sag is advantageous, since it means that the upper part 26 of the conveyor moves a fraction to and fro in a vertical direction during operation, which in turn prevents adhesion between the molded mass 14 and the upper part. Tightly fitted rollers furthermore require a far smaller drive unit than a fixed underlying surface, which needs a much larger motor power output due to the greater friction.

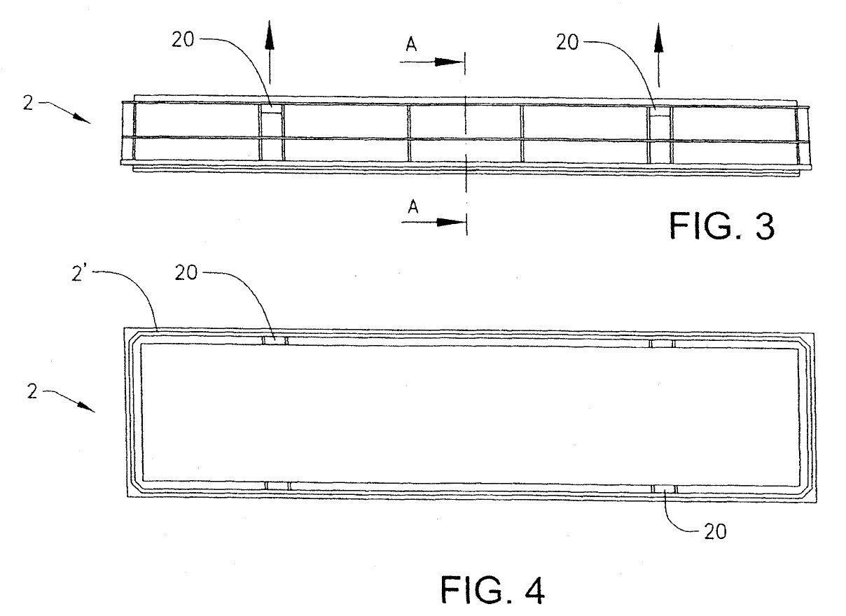

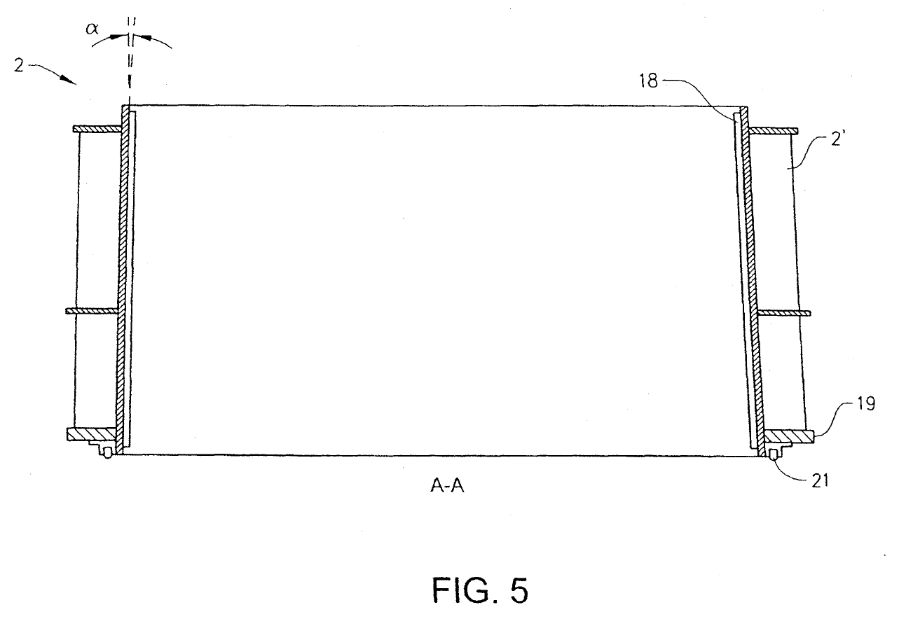

FIGS. 3-5 show the wall construction 2 according to a preferred embodiment, FIG. 3 showing a side view, FIG. 4 showing a top view of the wall construction and FIG. 5 showing a cross section A-A according to FIG. 3.

The wall construction 2 comprises a steel construction 2′, the main function of which is to provide the strength and which has an internal covering or lining 18 of a watertight material, such as plastic or water-resistant veneers, for example. Running along the underside of the wall construction 2 is a rubber gasket 21, intended to ensure a good seal with the upper part 26 of the first conveyor belt 1. The wall construction 2 furthermore comprises four lifting points 20.

As shown in FIG. 5, the wall construction 2 is designed with a slight taper to facilitate lifting from the finished molded mass 14, which is done when the mold changes underlying surface (mold base) between upper parts of the first and second conveyor belts 1 and 3 during the step-by-step transport from the casting and foaming unit 41 over to the cutting unit 42. As shown in FIG. 5, the walls of the wall construction 2 are at an angle α to a horizontal plane. A suitable value for the angle α is approximately 3°.

As shown in FIG. 5, a part of the steel construction 2′ forms the guide rails 19 as described above. The guide rails 19 run along a lower part of both longitudinal sides of the wall construction 2, that is to say in the conveying direction thereof. In step-by-step feeding with the first conveyor belt 1, and with the second conveyor belt 3, when this is connected to the first conveyor belt 1, the guide rails 19 run against the guide rollers 22, which are fitted to the stand 16 of the conveyors (see FIG. 6).

The molded mass 14 exerts a substantial pressure on the upper part 26, which means that the molded mass 14 and the upper part do not move relative to one another. The interaction between the guide rails 19 of the wall construction 2 and the guide rollers 22 therefore means that both the molded mass 14 and the upper parts 26 of the conveyor belts 1, 3 are centrally guided when being fed into the cutting arrangements of the cutting unit 42.

The wall construction 2 is removed from the conveyor belt in order to expose the molded mass 14 for dividing this up into smaller units. It can normally be lifted off from the molded mass 14 when this has been completely foamed and has attained a stable, plastic state. The wall construction 2, however, performs a cohesive function for the molded mass 14 and prevents cracking and changes in this during the step-by-step transport. For this reason it is lifted off only when the mold, that is to say the wall construction 2 and the molded mass 14, have come to rest on the second conveyor belt 3 and have thus changed mold base.

The dimensions of the wall construction 2 are in principle a matter of choice, but must, of course, be suitable for general handling, casting, transport on conveyor belts etc, and must be designed for the size of blocks, elements or beams that it is intended to produce. For example, the wall construction 2 may be of dimensions such that a finished and cut molded mass 14 has a length of 6 m, a width of 1.2 m and a height of 0.6 m, net.

FIG. 6 shows a cross section of a fully foamed molded concrete mass 14 in a wall construction 2 according to FIGS. 3-5, placed on a conveyor belt according to a preferred embodiment of the invention. FIG. 6 clearly shows how the guide rails 19 interact with the guide rollers 22, which are firmly fitted to the conveyor stand 16. FIG. 6 also shows a ball bearing conveyor roller 17, which supports the upper part 26 of the conveyor belt. A cross section of a lower part 26′ of the continuous belting of the conveyor is also shown in FIG. 6.

As shown in FIGS. 1 and 2, the upper part 26 of the first conveyor belt 1 is of a length which allows three wall constructions 2 in succession to be placed thereon. In this way an empty wall construction 2 can be put in place whilst another is being filled and a third is stationary undergoing foaming. The length of the first conveyor belt 1 and hence the number of wall constructions 2 that can be placed in a row thereon can be adapted, among other things, according to the planned production capacity and the space available.

The invention is not limited to the exemplary embodiment described above but may be varied without departing from the defined scope of the patent claims below. For example, it is not necessary to use more than the one, first conveyor belt 1; the same conveyor belt may run through both the casting and foaming unit 41 and the cutting unit 42. It is advantageous, however, to use at least two conveyors, since it is then possible to have one conveyor in the cutting unit driven independently of a preceding conveyor in the casting unit, for example. As described above, a further improvement is achieved by the use of at least three conveyor belts, which means that at least one conveyor can be located between and made connectable to a preceding conveyor and a succeeding conveyor, which are at least sometimes driven at different speeds or in different ways, one being driven in steps, for example, and the other continuously.

Multiple conveyor belts may furthermore be arranged in parallel in the casting and foaming unit 41 and/or the cutting unit 42. An intervening conveyor belt, corresponding to the second conveyor belt 3, may be arranged on the floor travelling crane for parallel movement and connection to the various conveyors.

As a variant, the arrangement for adding mould charge 30 may be moveable in the longitudinal direction of the conveyor, in order to avoid the requirement for step-by-step feeding of the first conveyor belt 1, for example. Such an arrangement may also be transversely moveable in order to allow mould charge to be added to multiple parallel conveyor belts.

Synchronized operation of the first and the second conveyor belts 1, 3 with the second and with the third conveyor belts 3, 4 respectively need not necessarily be done via a transmission and coupling as described previously, but may also be done by means of electronic control units.

As stated earlier, the plant according to the invention is primarily intended for the production of so-called lightweight or aerated concrete. Such concrete generally has a weight per unit volume of 0.4 to 0.6 kg/dm³, and sometimes up top 0.75 kg/dm³. The production of such concrete furthermore normally includes treatment in autoclaves as described above.

Ordinary homogeneous concrete normally has a weight per unit volume of 2-3 kg/dm³. Such a heavier type of concrete could be molded in a similar way to that proposed here, but normally requires another type of cutting equipment. This heavier type of concrete does not normally require autoclave treatment.

1. A plant for the production of concrete, comprising
a mould for a moulded concrete mass (14), the mould comprising a mould base and a wall construction (2) that can be removed from said base, the mould base of the mould consisting of an upper part (26) of a first conveyor belt (1), the wall construction (2) is designed to accompany the molded concrete mass (14) and to hold it together when the conveyor belt (1) is in operation.

2. The plant according to claim 1, further comprising:
guide devices (22) are arranged along each side of the upper part (26) of the first conveyor belt (1), said guide devices (22) designed, when the conveyor (1) is in operation, to interact with an outer part (19) of the wall construction (2) for positioning the wall construction (2) in a transverse direction to the longitudinal direction of the first conveyor belt (1).

3. The plant according to claim 2, wherein the guide devices (22) consist of guide rollers.

4. The plant according to claim 2, wherein, the wall construction (2) comprises a guide rail (19), which extends along both longitudinal sides of the wall construction (2), the guide rail (19) constituting the outer part which is intended to interact with the guide devices (22).

5. The plant according to claim 1, wherein the wall construction (2) comprises a steel construction provided with an inner covering (18) of a water-resistant material.

6. The plant according to claim 1, wherein the wall construction (2) comprises a rubber gasket (21) placed along the lower edge of the wall construction (2).

7. The plant according to claim 1, wherein the upper part (26) of the first conveyor belt (1) is designed to rest on an underlying surface which allows the upper part (26) to be kept plane.

8. The plant according to claim 7, wherein the underlying surface on which the upper part (26) rests comprises tightly seating conveyor rollers (17).

9. The plant according to claim 1, further comprising:
an arrangement for adding a mould mold charge (30) arranged to adjoin the first conveyor belt (1).

10. The plant according to claim 1, wherein the upper part (26) of the first conveyor belt (1) is of a length that allows at least two wall constructions (2) in succession to be placed thereon.

11. The plant according to claim 1, further comprising:
a second conveyor belt (3) is arranged in connection with the first conveyor belt (1), the operation of the second conveyor belt (3) synchronized with the first conveyor belt (1), so that an at least partially set moulded concrete mass can be transferred from the first conveyor belt (1) to the second conveyor belt (3).

12. The plant according to claim 11, further comprising:
a third conveyor belt (4) is arranged in connection with a preceding conveyor belt (3), the operation of the third conveyor belt (4) synchronized with the preceding conveyor belt (3), so that an at least partially set molded concrete mass can be transferred from the preceding conveyor belt (3) to the third conveyor belt (4), one or more cutting machines (5, 6, 7) for machining of the molded concrete mass (14) being arranged in connection with the third conveyor belt (4).

13. The plant according to claim 12, wherein the preceding conveyor belt (3) consists of the second conveyor belt (3).

14. The plant according to claim 1, further comprising:
at least two conveyor belts (3, 4) arranged in connection with one another in such a way that an at least partially set moulded concrete mass (14) can be transferred from one conveyor belt to the other, a longitudinal cutting machine (5) being located between said two conveyor belts (3, 4).

15. The plant according to claim 12, further comprising:
a fourth conveyor belt (12) arranged in connection with one end of the third conveyor belt (4), in such a way that waste from the machining by the cutting machines (5, 6, 7) that lands on the third conveyor belt (4) is transferred to and removed via the fourth conveyor belt (12).

16. The plant according to claim 11, wherein the wall construction (2) is designed to accompany the molded concrete mass (14) when transferring from the first conveyor belt (1) to the second conveyor belt (3).
